(19) United States
(12) Patent Application Publication
(10) Pub. No.: US 2026/0367619 A1
(43) Pub. Date: Nov. 19, 2026

(54) MOTION ANALYSIS METHOD AND PRODUCTION LINE MONITORING SYSTEM

(71) Applicant: Wistron Corporation, New Taipei City (TW)

(72) Inventors: Sheng Xuan Zheng, New Taipei City (TW); Yihsun Sung, New Taipei City (TW); Hongying Lin, New Taipei City (TW)

(73) Assignee: Wistron Corporation, New Taipei City (TW)

(21) Appl. No.: 19/250,072

(22) Filed: Jun. 26, 2025

(30) Foreign Application Priority Data
May 16, 2025 (CN) 202510637035.4

(51) Int. Cl. G05B 23/02; G06V 10/62; G06V 10/74; G06V 10/762; G06V 10/764; G06V 10/77; G06V 20/40

(52) U.S. Cl. CPC G05B 23/0216; G06V 10/62; G06V 10/761; G06V 10/763; G06V 10/764; G06V 10/7715; G06V 20/41; G06V 20/49

(57) ABSTRACT

This disclosure proposes a motion analysis method and a production line monitoring system. The method includes: obtaining a video related to an operation unit in a production line; segmenting the video into multiple training segments; extracting a training feature vector from each training segment and applying an unsupervised clustering algorithm to these training feature vectors to obtain multiple clustering groups that correspond to motions of the operation unit; generating a feature database based on the clustering groups; obtaining a video stream and segmenting the video stream into multiple inference segment; extracting an inference feature vector from each inference segment and inputting each inference feature to the feature database to classify it into one of the clustering groups to obtain a classification result; and determining a sequence or duration of the motions based on the classification result.

### CROSS-REFERENCE TO RELATED APPLICATION

This application claims the priority benefit of China application serial no. 202510637035.4, filed on May 16, 2025. The entirety of the above-mentioned patent application is hereby incorporated by reference herein and made a part of this specification.

### BACKGROUND

### Technical Field

The present disclosure relates to a motion analysis method for a production line and a production line monitoring system.

### Related Art

In the production line management of modern manufacturing industry, ensuring that the operations at each workstation are executed according to a predetermined sequence is a critical factor for improving production efficiency and product quality. Traditionally, production management system primarily relies on predefined workflows to facilitate seamless transitions between operations. However, with the advancement of production technology, basic sequence control has become insufficient to meet the demands of dynamic and variable modern production environments. This highlights the critical need for effective methodologies to monitor and adjust operational executions to ensure efficiency and adaptability.

Furthermore, during the operation process of the production line, the processing time of each workstation may be different, which may cause some workstations to have a heavier load, and in turn affect the overall production efficiency. For example, if the operation time of a certain workstation is significantly longer than other stations, it may become a production bottleneck, restricting overall production capacity and extending the production cycle. Therefore, for optimizing the production flow, various methods have been proposed in existing technologies to monitor the execution time of each operation, and make appropriate adjustments, by reducing the impact of production bottlenecks on production capacity.

### SUMMARY

For solving the above-mentioned problems, the present disclosure discloses a motion analysis method and a production line monitoring system.

An embodiment of the present disclosure discloses a motion analysis method, including: obtaining a video related to an operation unit of a production line, wherein this operation unit repeatedly performs multiple motions; segmenting the video into multiple training segments, wherein two adjacent training segments partially overlap with each other; extracting a training feature vector from each training segment, and executing an unsupervised clustering algorithm to these training feature vectors to obtain multiple clustering groups respectively corresponding to the motions of the operation unit; based on these clustering groups, establishing a feature database; obtaining a video stream, dividing the video stream into multiple inference segments, wherein two adjacent inference segments partially overlap; extracting an inference feature vector from each inference segment and inputting each inference feature vector to the feature database, classifying each inference feature vector as one clustering group to obtain a classification result; and according to the classification result, determining a sequence or duration of the motions.

From another perspective, another embodiment of the present disclosure discloses a production line monitoring system, including a video capture device and a computer system. The video capture device obtains a video stream. The computer system is communicatively connected to the video capture device, and configured to perform the aforementioned motion analysis method.

### BRIEF DESCRIPTION OF THE DRAWINGS

FIG. 1 is a schematic diagram illustrating a production line monitoring system according to an embodiment.

FIG. 2 is a flowchart illustrating a motion analysis method according to an embodiment.

FIG. 3 is a schematic diagram illustrating segmenting a video according to an embodiment.

FIG. 4 and FIG. 5 are schematic diagrams illustrating a hierarchical clustering algorithm according to an embodiment.

FIG. 6 is a schematic diagram illustrating a clustering algorithm considering density according to an embodiment.

FIG. 7 is a schematic diagram illustrating filtering processing according to an embodiment.

FIG. 8 is a schematic diagram illustrating a one-dimensional signal after filtering processing according to an embodiment.

### DESCRIPTION OF THE EMBODIMENTS

Some embodiments of the present disclosure will hereinafter be described in detail with reference to the accompanying drawings. The component symbols referenced in the following description, when the same component symbols appear in different drawings, are to be considered as the same or similar components. These embodiments are only a part of the present disclosure and do not disclose all ways the present disclosure may be implemented. More specifically, these embodiments are merely examples of the systems and methods within the claimed scope of the present disclosure.

Regarding ‘first’, ‘second’, etc. as used herein, they do not specifically denote order or sequence, but are merely for distinguishing components or operations described by the same technical term.

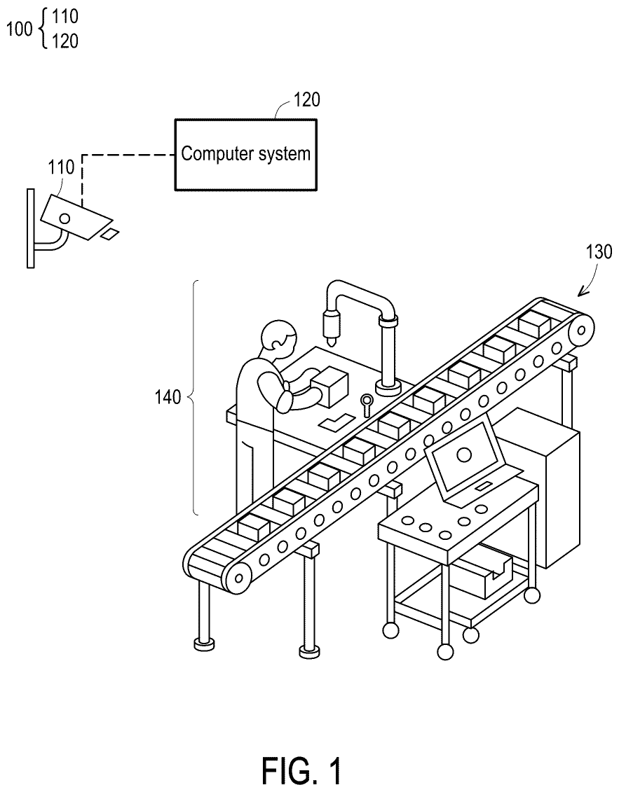

FIG. 1 is a schematic diagram illustrating a production line monitoring system according to an embodiment. A production line monitoring system 100 is applicable to a production line 130, and this production line 130 comprises at least one workstation 140. In some embodiments, the production line 130 is for manufacturing notebook computers, and the workstation 140 performs multiple repetitive motions such as placing fans, inserting cables, and tightening screws. In other embodiments, the production line 130 may also be applicable to the manufacturing of other products such as automobiles, home appliances, and mobile phones, and the present disclosure does not limit the use of the production line 130, nor does it limit the types of motions involved with the workstation 140.

In some embodiments, the workstation 140 refers to an operation unit on the production line 130, and its function is to execute one or more specific production processes or tasks. This operation unit may include but is not limited to: personnel, automated robotic arms, or any other equipment with the capability to perform repetitive motions. To ensure a smooth and efficient production flow, this operation unit must repetitively perform the aforementioned multiple motions at the workstation 140. The production line monitoring system 100 monitors and analyzes the motions of the operation unit, and computes the execution sequence or duration of these motions, by video analysis technology.

The production line monitoring system 100 comprises a video capture device 110 and a computer system 120. The video capture device 110 acquires video data of the workstation 140, and it may include a Charge-coupled Device (CCD) sensor, a Complementary Metal-Oxide Semiconductor (CMOS) sensor, or other suitable photosensitive components. In some embodiments, the video capture device 110 may further include dual cameras, a structured light sensing device, a laser, or any component that may sense scene depth. The computer system 120 executes subsequent video analysis and processing. The computer system 120 is, for example, a server, a personal computer, a notebook computer, or other electronic devices with computing capability. The computer system 120 is communicatively connected to the video capture device 110 through wired or wireless means, whereby the computer system 120 obtains the video stream captured by the video capture device 110. In some embodiments, the computer system 120 may also directly control the production line 130 and the workstation 140, or indirectly control the production line 130 and the workstation 140 through other control centers. The computer system 120 may extract information about the production line 130, and may also issue control signals to control the operation of the production line 130. Furthermore, the computer system 120 will execute a motion analysis method which will be described below.

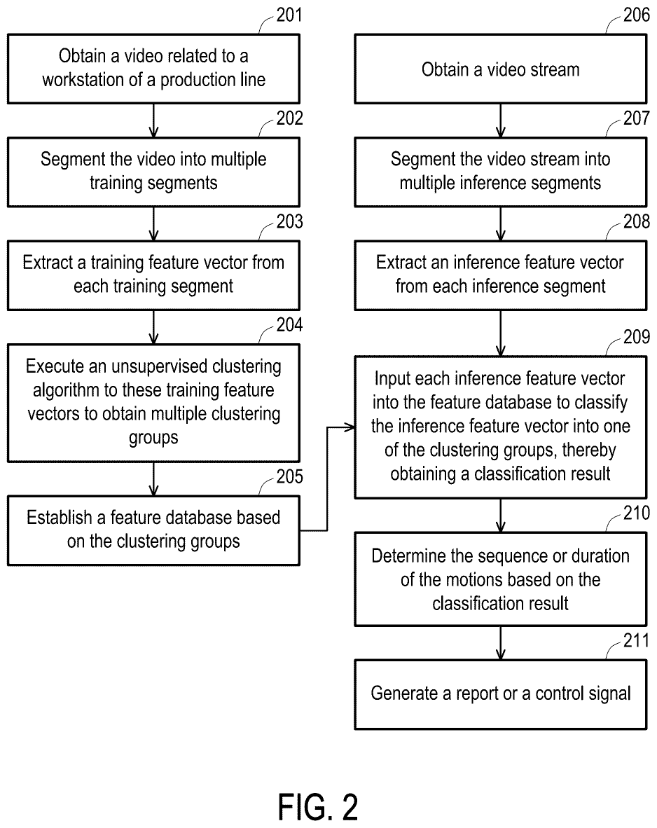

FIG. 2 is a flowchart illustrating a motion analysis method according to an embodiment. This motion analysis method includes step 201 to step 211, wherein the step 201 to step 205 belong to a training stage, and the step 206 to step 211 belong to an inference stage.

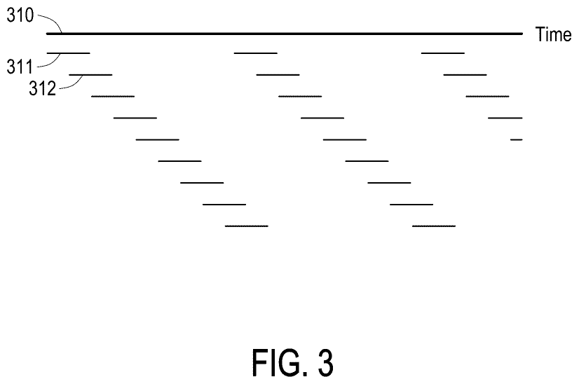

In step 201, a video related to a workstation of a production line is obtained. In step 202, this video is segmented into multiple training segments, wherein two adjacent training segments partially overlap with each other. FIG. 3 is a schematic diagram illustrating segmenting a video according to an embodiment. Please refer to FIG. 3, the horizontal axis represents time, and the length of the video 310 is, for example, 5 minutes, but this disclosure is not limited thereto. The video 310 is segmented into a plurality of mutually overlapping training segments (e.g. training segments 311 and 312). Since the training segments partially overlap, contextual information is preserved, ensuring that the continuity of motions is not disrupted. In this embodiment, the length of each training segment 311, 312 is 4 seconds, and the stride is 0.5 seconds, but this disclosure is not limited thereto. When the stride is set to be smaller, an accurate result may be obtained, but it also consumes more computing resources. In some embodiments, the stride may be set according to the desired computing resources and accuracy. In some embodiments, if the operation unit of the workstation 140 requires a longer time to perform a motion, the length of the segment may also be set to be greater than 4 seconds.

Please refer to FIG. 2. In step 203, a training feature vector is extracted from each training segment. Herein, any machine learning model may be adopted to obtain the training feature vector; for example, TimeSformer, Cosmos Tokenizer, etc. may be adopted, and this disclosure is not limited thereto. In some embodiments, the training segments may be normalized before inputting to the machine learning model, for example, by performing resizing to a fixed width and height. In some embodiments, the width and height of a frame are 1920 and 1080, respectively, and after normalization are 512 and 512, respectively. In this embodiment, the frame rate of the video is 20 fps, the length of each training segment is 4 seconds, and therefore, one training segment comprises a total of 80 frames. After normalization, the width and height of each frame are both 512 pixels, and each pixel has three channels such as red, green, and blue; therefore, one training segment may be represented as a vector with a length of 80*3*512*512. On the other hand, the length of the training feature vector is, for example, 16*11*64*64. The size of the aforementioned feature vector is merely an example, and in other embodiments, longer or shorter feature vectors may also be generated.

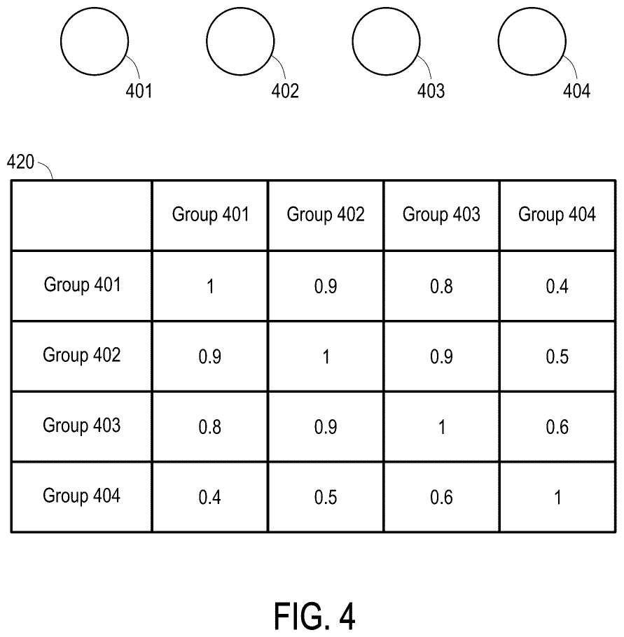

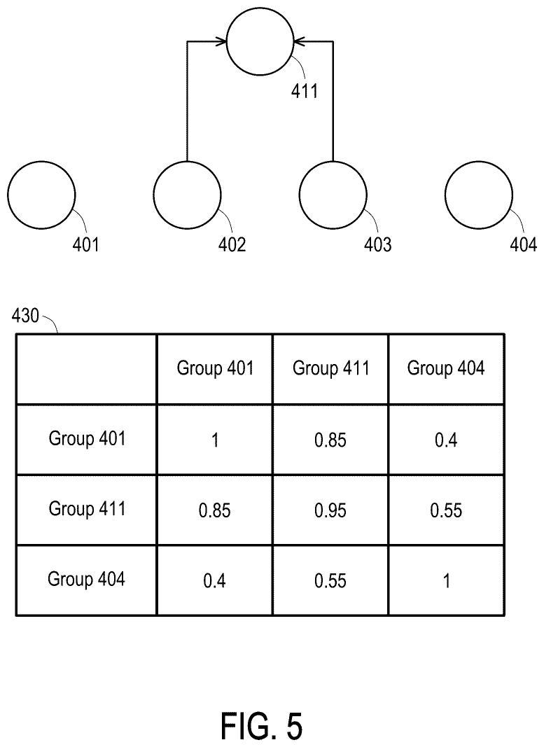

In step 204, an unsupervised clustering algorithm is executed to these training feature vectors to obtain multiple clustering groups, and these clustering groups will correspond to multiple motions performed by the operation unit of the workstation. In some embodiments, the unsupervised clustering algorithm is a hierarchical clustering algorithm. FIG. 4 and FIG. 5 are schematic diagrams illustrating the Hierarchical Clustering algorithm according to an embodiment. Please refer to FIG. 4, first, each training feature vector is set as a candidate clustering group, for example, as candidate clustering groups 401 to 404. Next, the similarity between every two training feature vectors is calculated, the calculation result is shown in a table 420. For simplicity, the table 420 displays “group” instead of “candidate clustering group”. In some embodiments, the similarity is, for example, cosine similarity, but this disclosure is not limited thereto. The diagonal line in the table 420 represents the similarity of each candidate clustering group with itself, therefore the value is 1. The similarity between the candidate clustering group 401 and the candidate clustering group 402 is 0.9, and so on. Next, the two most similar candidate clustering groups are merged. That is, the similarity with the largest value except for the diagonal line is selected from the table 420 (if there are multiple largest similarities, then one may be randomly selected), and merging the corresponding two candidate clustering groups; in this example, the ones to be merged are the candidate clustering group 402 and the candidate clustering group 403.

Next, the similarity between the merged candidate clustering group and other candidate clustering groups is calculated. Referring to FIG. 4 and FIG. 5, after the candidate clustering group 402 and the candidate clustering group 403 are merged into a candidate clustering group 411, the calculation results are shown in a table 430. When calculating the similarity between the candidate clustering group 411 and the candidate clustering group 401, the similarity (i.e., 0.9) between the candidate clustering group 402 and the candidate clustering group 401 and the similarity (i.e., 0.8) between the candidate clustering group 403 and the candidate clustering group 401 are calculated, and the average of these two similarities (i.e., 0.85) is used as the similarity between the candidate clustering group 411 and the candidate clustering group 401. The same applies to the calculation of other similarities. When calculating the similarity between candidate clustering group 411 and itself, the average of 1 and 0.9 (i.e., 0.95) is calculated; however, since the candidate clustering group 411 will not be merged with itself, this value does not affect the subsequent merging process. The merging steps described above are then repeated until the count of merged candidate clustering groups is equal to a preset number (i.e., the count of the motions performed by the operation unit in the workstation, which is determined either manually or by a classifier). Finally, the clustering groups generated by the unsupervised clustering algorithm are obtained.

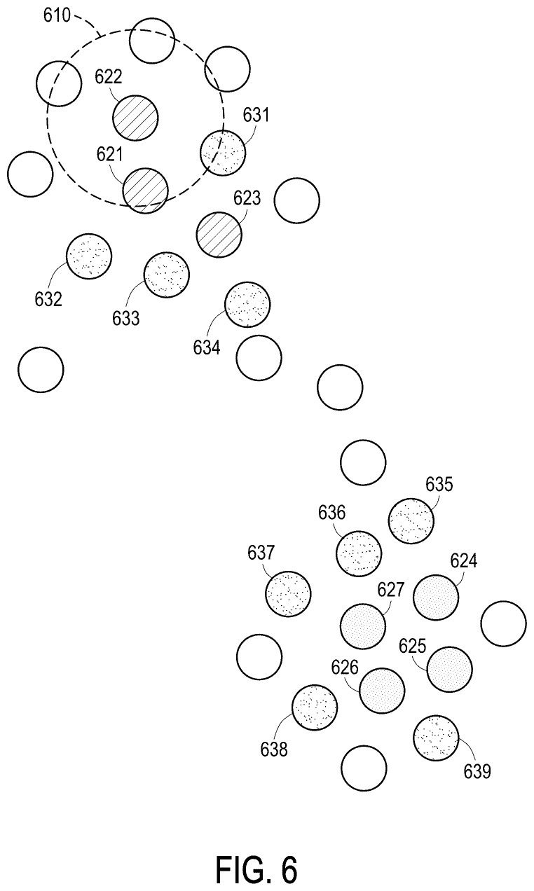

In other embodiments, the unsupervised clustering algorithm considers the “density” of the training feature vectors. As the aforementioned training segments partially overlap, there will be a phenomenon of transitioning from one clustering group to another clustering group when clustering is executed. FIG. 6 is a schematic diagram illustrating a clustering algorithm that considers density according to an embodiment. Please refer to FIG. 6, each small circle represents a training feature vector. First, a neighbor count of each training feature vector is determined according to a distance threshold which is represented as a circle 610 of FIG. 6, and the neighbor count represents the count of the training feature vectors in this circle 610. In some embodiments, the distance between two training feature vectors may be computed with Euclidean distance, but this disclosure is not limited thereto.

Next, for each training feature vector, if its neighbor count is greater than a first threshold, then this training feature vector is set as a core point; if its neighbor count is less than or equal to the first threshold and greater than a second threshold, then this training feature vector is set as a transition point. The aforementioned first threshold is greater than the second threshold, for example, the first threshold is 4, and the second threshold is 2. In the embodiment of FIG. 6, training feature vectors 621 to 627 are set as core points, and training feature vectors 631 to 639 are set as transition points.

Next, a core point (also referred to as a first core point) is randomly selected to be a first group. The core points around the first core point within the distance threshold are set to be in the first group. The first group continuously expands from the core points newly added to the first group. For example, the training feature vector 622 is first selected as the first core point, and this first core point is set to be the first group. As the training feature vector 621 belongs to the core points within the distance threshold, the training feature vector 621 is also added to the first group. Next, the first group expands from the training feature vector 621. As the training feature vector 623 belongs to core points and the distance between the training feature vector 621 and the training feature vector 623 is less than the distance threshold, the training feature vector 623 is also added to the first group. For other core points, as they are not within the distance threshold, and therefore they will not be added to the first group.

Next, a core point that has not yet been grouped (referred to as ungrouped core point) is selected, and this ungrouped core point is set to be a second group. The aforementioned expansion step is repeated for the second group, until all core points are processed. For example, the training feature vector 624 is selected as a second core point, and this second core point is set to be the second group. Then, the training feature vectors 625 to 627, are added to the second group.

According to the above approach, multiple candidate groups are continuously formed until all core points are processed. Depending on the count of the candidate groups, three scenarios may occur. First, if the count of the candidate groups is equal to the preset number (i.e., the number of motion performed by the operation units in the workstation), the remaining transition points are classified into one of the candidate groups. In this case, a centroid is calculated for each candidate group, and the distance from each transition point to the centroids is computed. Each transition point is then assigned to the group corresponding to the closest centroid. For example, the training feature vectors 631-634 are closer to the centroid of the first group and are therefore assigned to the first group, while the training feature vectors 635-639 are closer to the centroid of the second group and thus assigned to the second group. In this scenario, the candidate groups are referred to as the clustering groups generated by the unsupervised clustering algorithm.

Second, if the count of the candidate groups is less than the preset number, the distance threshold is reduced and the clustering process is repeated. That is, based on the newly set distance threshold, the neighbor counts are recalculated, and the training feature vectors are reclassified into core points and transition points. Reducing the distance threshold results in fewer core points, which are more sparsely distributed, thereby leading to the formation of more groups. After generating additional groups, the process may return to the first scenario above or proceed to the third scenario below.

Third, if the count of the candidate groups is greater than the count of the motions, a distance summation among each pair of candidate groups and the transition points is calculated. This calculation is shown in the following Equation (1).

### [Equation 1]

$${T}_{i , j} = {\sum }_{k} {\vert {x}_{i} - {x}_{k} \vert}^{2} + {\vert {x}_{j} - {x}_{k} \vert}^{2}$$

Wherein xᵢ represents the centroid of the i-th candidate group, xⱼ represents the centroid of the j-th candidate group, xₖ is the k-th transition point, and i, j, k are positive integers. T_{i,j} is the distance summation between the i-th candidate group and the j-th candidate group. If there are more transition points between two candidate groups, then the computed distance summation is smaller; conversely, if there are fewer transition points between two candidate groups, then the computed distance summation is larger. A smaller distance summation reflects that the two candidate groups may be corresponding to the same motion, and this motion may be classified into two different candidate groups because of larger variations. Therefore, next, the two candidate groups corresponding to the minimum distance summation are merged, and then the operations of computing distance summation and merging is repeated, until the count of candidate groups is equal to the count of the motions. Finally, these candidate groups may be output as multiple clustering groups generated by the unsupervised clustering algorithm. Through the aforementioned method, density and a fixed quantity of groups are both considered.

Please refer to FIG. 2, after the step 204 is executed, multiple clustering groups are obtained. Next, the centroid of each clustering group is calculated for the inference stage. Since the clustering groups generated by the step 204 do not have specific motion labels, in some embodiments, a person may observe training segments belonging to the same clustering group and assign a motion label (for example, placing a fan). In other embodiments, the motion labels are assigned through a classifier. Specifically, each training feature vector in the clustering groups is input into the classifier (some training feature vectors may not have been classified into any group). This classifier is, for example, a decision tree, a random forest, a k-nearest neighboring algorithm, a Multilayer Perceptron (MLP), a convolutional neural network, a support vector machine, XGBoost, etc. The classifier will output one of multiple motion labels which respectively corresponding to multiple motions performed by the operation unit in the workstation. For example, these motion labels are respectively placing a fan, inserting a cable, and tightening a screw. Next, for each clustering group, the motion label of the clustering group is determined based on the motion labels of the training feature vectors in this clustering group; for example, the motion label of the clustering group may be determined through voting. After the motion labels of the clustering groups are set, each clustering group will then be assigned to a motion of the operation unit in the workstation.

In step 205, a feature database is established based on the clustering groups. For example, the feature database includes centroids of the clustering groups. This feature database may be stored in the computer system 120, or in another device accessible by the computer system 120.

In step 206, first, a video stream is obtained. The video stream is also related to the operation unit of the production line, and this video stream includes multiple frames. In step 207, the video stream is segmented into multiple inference segments, this step is the same as the step 202. Therefore, two adjacent inference segments will overlap with each other. In some embodiments, since the video stream may have different real-time frame rates due to factors such as network speed, computing resources, etc., when this real-time frame rate is different from the frame rate of the video in the training stage, some errors may be generated. Therefore, in some embodiments, frame generation or frame discarding may be executed to the frames in the video stream, such that the frame rate of the inference segments is the same as the frame rate of the video in the train stage. For example, the frame rate of the video in the training stage is 20 fps, when the real-time frame rate of the video stream is 40 fps, one frame may be discarded from every two frames, such that the frame rate of the inference segments is also 20 fps. Alternatively, when the real-time frame rate of the video stream is 10 fps, one frame may be generated between every two frames, such that the frame rate of the inference segments is also 20 fps. The aforementioned frame generation or frame discarding may use any interpolation method or generation model which is not limited in the present disclosure.

In step 208, an inference feature vector is extracted from each inference segment, using the same model as in the step 203. In step 209, each inference feature vector is input into the feature database to classify the inference feature vector into one of the clustering groups, thereby obtaining a classification result. In some embodiments, for each inference feature vector, the similarities between the inference feature vector and the centroids of the clustering groups are calculated, and the inference feature vector is classified into the clustering group associated with the closest centroid (i.e. the most similar centroid).

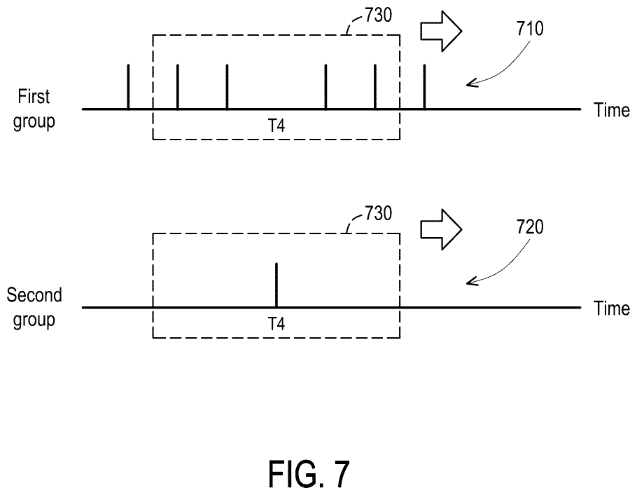

In some embodiments, the above-mentioned classification result is represented as a time series, where each time point in the time series includes one or more values indicating the corresponding clustering group. In certain embodiments, the classification results may contain noise, and therefore a filtering process may be applied to eliminate the noise. FIG. 7 is a schematic diagram illustrating the filtering process according to one embodiment. Referring to FIG. 7, for each clustering group, a one-dimensional signal is generated based on the classification results associated with that clustering group. For example, one-dimensional signal 710 corresponds to the first clustering group. When an inference segment belongs to the first clustering group, the value of the signal 710 at the corresponding time point is 1; otherwise, the value is 0. One-dimensional signal 720 corresponds to the second clustering group. Since the time points are discrete, the values at each time point are represented as pulse signals. In the embodiment shown in FIG. 7, the first three inference segments belong to the first clustering group, the fourth inference segment belongs to the second clustering group, and the fifth to seventh segments belong to the first clustering group.

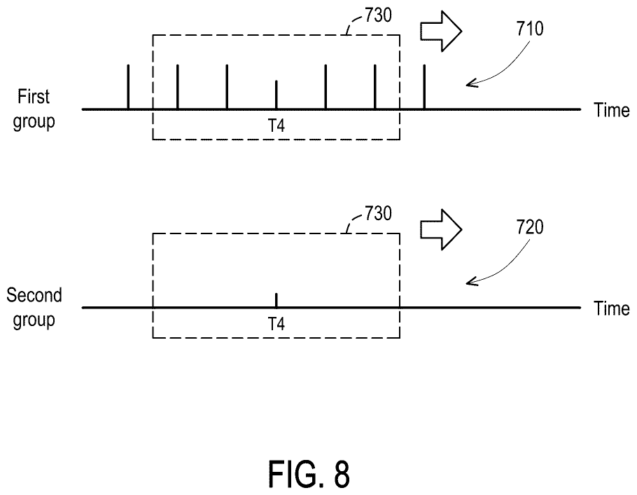

Next, each of the one-dimensional signals 710 and 720 undergoes a filtering process. This filtering process includes a filter 730, with the center of the filter 730 positioned at time point T4. The filter 730 moves along the time axis in a manner commonly referred to as a moving window. In this example, the width of the filter 730 is 5, and the weights within the filter are determined according to a Gaussian distribution or other distributions. The filtered results are shown in FIG. 8. Subsequently, the amplitudes of the filtered one-dimensional signals are compared at each time point. The clustering group corresponding to a time point is determined based on which filtered one-dimensional signal has the largest amplitude at that time point. For example, the amplitude of the one-dimensional signal 710 is greater than that of the one-dimensional signal 720 at time point T4 after the filtering process. Therefore, the inference segment corresponding to the time point T4 is classified into the first clustering group.

Referring back to FIG. 2, in step 210, the sequence or duration of the motions is determined based on the classification result. For example, if there are 100 consecutive inference segments classified into the first clustering group, it indicates that the duration of the motion corresponding to the first clustering group is 100*0.5=5 seconds. If this is followed by 50 consecutive inference segments belonging to the second clustering group, it means the duration of the motion corresponding to the second clustering group is 50*0.5=2.5 seconds. Based on this classification result, the action corresponding to the first clustering group occurs first, followed by the action corresponding to the second clustering group.

In step 211, a report or control signal is generated. For example, if the motion sequence or duration determined in the step 210 does not conform to a predefined reference standard, a control signal may be generated to halt the production line, or a warning signal may be issued. For instance, if the reference standard specifies the sequential execution of placing a fan, plugging in a cable, and fastening screws, but the determined motion sequence only includes placing the fan and fastening screws—omitting the plugging in step—then it is considered non-compliant with the reference standard. Alternatively, if the reference standard specifies that the execution time of these motions should not exceed 5 minutes, but the duration determined in the step 210 exceeds 5 minutes, this would also be non-compliant. The generated control signal may be sent to the control center of the production line 130 to suspend its operation, or the computer system 120 may directly control the operation of the production line 130. In some embodiments, it is also possible to calculate the average time required for each operation unit to perform each motion, or to compute the efficiency of each operation unit. This information can be used to generate management reports. Based on these reports, administrators can identify bottlenecks in the production line and adjust the workstation units accordingly. For example, if the average time required at a particular workstation is significantly greater than that at other workstations, the administrator may allocate additional units to that workstation.

Although the present disclosure has been disclosed as above by embodiments, however, it is not to limit the present disclosure, any person having ordinary skill in the art, without departing from the spirit and scope of the present disclosure, may make some modifications and embellishments, therefore, the protection scope of the present disclosure is subject to what is determined by the appended claims.

What is claimed is:

1. A motion analysis method for a production line monitoring system, the motion analysis method comprising:
obtaining a video, wherein the video is related to an operation unit in a production line, the operation unit repeatedly performs a plurality of motions;
segmenting the video into a plurality of training segments, wherein adjacent two of the training segments partially overlap with each other;
extracting a training feature vector from each of the training segments, and executing an unsupervised clustering algorithm on the training feature vectors to generate a plurality of clustering groups, wherein the clustering groups respectively correspond to the motions;
establishing a feature database based on the clustering groups;
obtaining a video stream and dividing the video stream into multiple inference segments, wherein adjacent two of the inference segments partially overlap with each other;
extracting an inference feature vector from each of the inference segments, and inputting the inference feature vectors to the feature database, classifying each of the inference feature vectors as one of the clustering groups to generate a classification result; and
determining a sequence or a duration of the motions according to the classification result.

2. The motion analysis method as claimed in claim 1, wherein the unsupervised clustering algorithm comprises:
(a) setting each of the training feature vectors as a candidate clustering group;
(b) computing a similarity between every two of the training feature vectors;
(c) merging two most similar candidate clustering groups among the candidate clustering groups, and computing a similarity between the merged candidate clustering group and other candidate clustering groups; and
repeating the step (c), until a quantity of the merged candidate clustering groups is equal to a quantity of the motions.

3. The motion analysis method as claimed in claim 2, wherein the two most similar candidate clustering groups include a first candidate clustering group and a second candidate clustering group, and the step (c) comprises:
computing an average of a first similarity between the first candidate clustering group and the other candidate clustering groups, and a second similarity between the second candidate clustering group and the other candidate clustering groups, and using the average as the similarity between the merged candidate clustering group and the other candidate clustering groups.

4. The motion analysis method as claimed in claim 1, wherein the unsupervised clustering algorithm comprises:
(a) determine a neighbor count of each of the training feature vectors according to a distance threshold;
(b) for each of the training feature vectors, if the corresponding neighbor count is greater than a first threshold then setting the training feature vector as a core point, if the corresponding neighbor count is less than or equal to the first threshold and greater than a second threshold then setting the training feature vector as a transition point, wherein the first threshold is greater than the second threshold;
(c) selecting a first core point from the core points, setting the first core point as a first group, and setting the core points within the distance threshold around the first core point to be in the first group, and continuously expanding from the core points newly added to the first group; and
(d) after expansion of the first group, selecting a second core point from the ungrouped core points, and repeating the step (c) to establish a second group until all of the core points are processed, to generate a plurality of candidate groups.

5. The motion analysis method as claimed in claim 4, wherein the unsupervised clustering algorithm further comprises:
(e) if a count of the candidate groups is equal to the count of the motions, classifying each of the transition points as one of the candidate groups;
(f) if the count of the candidate groups is less than the count of the motions, reducing the distance threshold and repeating the steps (a) to the step (d);
(g) if the count of the candidate groups is greater than the count of the motions, for every two of the candidate groups, calculating a distance summation among the two of the candidate groups and the transition points;
(f) merging the two of the candidate groups corresponding to a minimum distance summation, and repeating the step (g), until the count of the candidate groups is equal to the count of the motions.

6. The motion analysis method as claimed in claim 1, further comprising:
inputting each of the training feature vectors in the clustering groups into a classifier to generate one of a plurality of motion labels, wherein the motion labels respectively correspond to the motions; and
for each of the clustering groups, assigning the clustering group to one of the motions based on the motion labels of the training feature vectors in the clustering group.

7. The motion analysis method according to claim 1, wherein the video stream comprises a plurality of frames, and the motion analysis method comprises:
performing frame generation or frame discarding on the frames such that a frame rate of the inference segments is equal to a frame rate of the video stream.

8. The motion analysis method according to claim 1, wherein classifying each of the inference feature vectors into one of the motions to obtain the classification result includes:
calculating a centroid for each of the clustering groups; and
for each of the inference feature vectors, calculating the similarities between the inference feature vector and the centroids, and classifying the inference feature vector into the clustering group associated with a closest centroid.

9. The motion analysis method according to claim 7, wherein classifying each of the inference feature vectors into one of the actions to obtain the classification result includes:
for each of the clustering groups, generating a one-dimensional signal based on the classification result belonging to the clustering group;
performing a filtering process on each of the one-dimensional signals; and
comparing amplitudes of the filtered one-dimensional signals at a time point, and determining one of the clustering groups based on the one-dimensional signal having a maximum amplitude.

10. The motion analysis method according to claim 1, further comprising:
in response to the sequence or the duration not satisfying a preset criterion, generating a control signal to pause the production line.

11. The motion analysis method according to claim 1, further comprising:
calculating an average time for the operation unit to perform the motions, and generating a report according to the average time.

12. A production line monitoring system, comprising:
a video capture device, configured to obtain a video stream; and
a computer system, communicatively connected to the video capture device, configured to perform a plurality of steps:
obtaining a video, wherein the video is related to an operation unit in a production line, the operation unit repeatedly performs a plurality of motions;
segmenting the video into a plurality of training segments, wherein adjacent two of the training segments partially overlap with each other;
extracting a training feature vector from each of the training segments, and executing an unsupervised clustering algorithm on the training feature vectors to generate a plurality of clustering groups, wherein the clustering groups respectively correspond to the motions;
establishing a feature database based on the clustering groups;
dividing the video stream into multiple inference segments, wherein adjacent two of the inference segments partially overlap with each other;
extracting an inference feature vector from each of the inference segments, and inputting the inference feature vectors to the feature database, classifying each of the inference feature vectors as one of the clustering groups to generate a classification result; and
determining a sequence or a duration of the motions according to the classification result.

13. The production line monitoring system as claimed in claim 12, wherein the unsupervised clustering algorithm comprises:
(a) setting each of the training feature vectors as a candidate clustering group;
(b) computing a similarity between every two of the training feature vectors;
(c) merging two most similar candidate clustering groups among the candidate clustering groups, and computing a similarity between the merged candidate clustering group and other candidate clustering groups; and
repeating the step (c), until a quantity of the merged candidate clustering groups is equal to a quantity of the motions.

14. The production line monitoring system as claimed in claim 13, wherein the two most similar candidate clustering groups include a first candidate clustering group and a second candidate clustering group, and the step (c) comprises:
computing an average of a first similarity between the first candidate clustering group and the other candidate clustering groups and a second similarity between the second candidate clustering group and the other candidate clustering groups, and using the average as the similarity between the merged candidate clustering group and the other candidate clustering groups.

15. The production line monitoring system as claimed in claim 12, wherein the unsupervised clustering algorithm comprises:
(a) determine a neighbor count of each of the training feature vectors according to a distance threshold;
(b) for each of the training feature vectors, if the corresponding neighbor count is greater than a first threshold then setting the training feature vector as a core point, if the corresponding neighbor count is less than or equal to the first threshold and greater than a second threshold then setting the training feature vector as a transition point, wherein the first threshold is greater than the second threshold;
(c) selecting a first core point from the core points, setting the first core point as a first group, and setting the core points within the distance threshold around the first core point to be in the first group, and continuously expanding from the core points newly added to the first group; and
(d) after expansion of the first group, selecting a second core point from the ungrouped core points, and repeating the step (c) to establish a second group until all of the core points are processed, to generate a plurality of candidate groups.

16. The production line monitoring system as claimed in claim 15, wherein the unsupervised clustering algorithm further comprises:
(e) if a count of the candidate groups is equal to the count of the motions, classifying each of the transition points as one of the candidate groups;
(f) if the count of the candidate groups is less than the count of the motions, reducing the distance threshold and repeating the steps (a) to the step (d);
(g) if the count of the candidate groups is greater than the count of the motions, for every two of the candidate groups, calculating a distance summation among the two of the candidate groups and the transition points;
(f) merging the two of the candidate groups corresponding to a minimum distance summation, and repeating the step (g), until the count of the candidate groups is equal to the count of the motions.

17. The production line monitoring system as claimed in claim 12, wherein the steps further comprise:
inputting each of the training feature vectors in the clustering groups into a classifier to generate one of a plurality of motion labels, wherein the motion labels respectively correspond to the motions; and
for each of the clustering groups, assigning the clustering group to one of the motions based on the motion labels of the training feature vectors in the clustering group.

18. The production line monitoring system according to claim 12, wherein the video stream comprises a plurality of frames, and the steps further comprise:
performing frame generation or frame discarding on the frames such that a frame rate of the inference segments is equal to a frame rate of the video stream.

19. The production line monitoring system according to claim 12, wherein classifying each of the inference feature vectors into one of the motions to obtain the classification result includes:
calculating a centroid for each of the clustering groups; and
for each of the inference feature vectors, calculating the similarities between the inference feature vector and the centroids, and classifying the inference feature vector into the clustering group associated with a closest centroid.

20. The production line monitoring system according to claim 18, wherein classifying each of the inference feature vectors into one of the actions to obtain the classification result includes:
for each of the clustering groups, generating a one-dimensional signal based on the classification result belonging to the clustering group;
performing a filtering process on each of the one-dimensional signals; and
comparing amplitudes of the filtered one-dimensional signals at a time point, and determining one of the clustering groups based on the one-dimensional signal having a maximum amplitude.

21. The production line monitoring system according to claim 12, wherein the steps further comprise:
in response to the sequence or the duration not satisfying a preset criterion, generating a control signal to pause the production line.

22. The production line monitoring system according to claim 12, wherein the steps further comprise:
calculating an average time for the operation unit to perform the motions, and generating a report according to the average time.
